(19) United States
(12) Patent Application Publication
(10) Pub. No.: US 2008/0306822 A1
(43) Pub. Date: Dec. 11, 2008

(54) Self Funding Emergency and Other Notification System

(76) Inventors: Craig A. Nulan, Kansas City, MO (US); John V. Toms, Kansas City, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/117,595

(22) Filed: May 8, 2008

Related U.S. Application Data
(60) Provisional application No. 60/916,712, filed on May 8, 2007.

(51) Int. Cl. G06Q 30/00

(52) U.S. Cl. 705/14

(57) ABSTRACT

The present invention is directed to a business model, methods, and system for generating and distributing telecom and Internet advertising revenue between a voice message broadcast provider and partner social network. The inventive business model provides voice message broadcast services to a social network, self-configured by the administrators and members of that social network via an Internet web-interface. The web-interface, furnished to the social network by the voice message broadcast service provider, converges the interests of the social network's administrators, the social network's members, interested non-members, and 3^{rd} parties that want to telephonically reach call recipients affiliated with the social network.

### CROSS-REFERENCE TO RELATED APPLICATION

This application claims priority of U.S. provisional patent application Ser. No. 60/916,712, filed May 8, 2007. The entire teachings of the above application is incorporated herein by reference.

### BACKGROUND OF THE INVENTION

1. Field of the Invention

The invention consists of an Internet web-interface to user administrable telecommunications switching software. This software delivers targeted voice messaging to the telephone and mobile phone. Our customers are social networks, the individual members comprising social networks, and 3rd party businesses and advertisers that want to reach members of these social networks telephonically. In conjunction with the web-interface that maps and controls message authorization and utilization by a social network and its membership, we enable advertisers to reach customers and prospective customers via voice on the phone/mobile phone. This invention relates to methods for generating and/or distributing revenue in return for access to authorized call recipients. More specifically, the invention is directed to a business model and method for generating and distributing Telecom and Internet revenue produced when a member of a social network authorizes the receipt of 3rd party telephonic voice advertisements and public service announcements. 3rd parties present their voice message content to individuals who opt-in to receive these messages through a web-site. The web-site carries the brand characteristics of the social network to which the individual belongs.

2. Description of the Related Art

Wired telephones and wireless mobile telephones are the last remaining medium where the user has to bear the entire cost of message content. That is a significant barrier to the introduction of advertising content that phone users might be willing to accept. In addition, state and federal Do Not Call Registry law limits calls to phone customers who do not elect to receive such calls. Privacy and compliance with Do Not Call Registry laws are big issues, that must be resolved for telephonic advertising to be successful.

Carriers and advertisers have introduced various styles of advertising taken directly from an Internet web-model with methods including banners, text messages and multimedia messages, as well as video spots before, during or after a video content clip. None of these has proven acceptable to the overwhelming majority of telephone users.

The personalized nature of wired and wireless telephones is a double-edged sword: it is what makes the medium appealing to advertisers, but many phone users consider the medium too personal to be invaded by outside interests. In addition, the telephone industry lacks common technical standards that would make it easy for advertisers to sell their Internet web-advertising methods and techniques to many carriers/operators at once. The phone can reach everybody and it's always on, but there are presently no defined industry standards to enable carriers and advertisers to benefit from this universality of use.

Fundamentally, a telephone is a voice communications technology. From the perspective of advertising, because of an industry-wide focus on imposing Internet web structures on the telephone, widespread adoption of practical methods for communicating advertising information have stalled. At this point, from an advertising perspective, the wired and wireless telephone remains a largely pristine medium. Telephone users will not opt in to receive communications 24/7, but will perhaps authorize voice messaging at certain times of day and for certain types of communication.

The present model, methods, and invention take all the above criteria into consideration and provide a novel solution that simultaneously overcomes each of these barriers to the current art.

### SUMMARY OF THE INVENTION

The invention is directed to a business model, methods, and a system for generating and distributing telecom and Internet revenue produced when a member of a social network authorizes the receipt of 3rd party telephonic voice advertisements and public service announcements. Methods supporting the business model conduce to the routine acceptance and use of authorized voice messages from the social network to its members—while providing a means for incorporating authorized 3rd party voice messages (advertisements and public service announcements) into the routine voice messaging activity used by members of the social network. Further, the methods and implementing system provide economic incentives to increase sponsored voice message acceptance and usage by the social network for routine organizational purposes.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a diagram of the present general inventive concept illustrating a church voice message broadcast (VMB) example.

FIG. 2 is a diagram of the present general inventive concept illustrating an internet web-interface for group creation.

FIG. 3 is a diagram of the present general inventive concept illustrating an internet web-interface for inviting VMB group members.

FIG. 4 is a diagram of the present general inventive concept illustrating an internet web-interface for bulk upload of VMB group members.

FIG. 5 is a diagram of the present general inventive concept illustrating an internet web-interface for creating VMB groups and publishing public ones to the web.

FIG. 6 is a diagram of the present general inventive concept illustrating an internet web-interface for members and non-members to join public VMB groups.

FIG. 7 is a diagram of the present general inventive concept illustrating a screen shot of a successful click to subscribe to a public VMB group.

FIG. 8 is a diagram of the present general inventive concept illustrating an internet web-interface showing VMB call results.

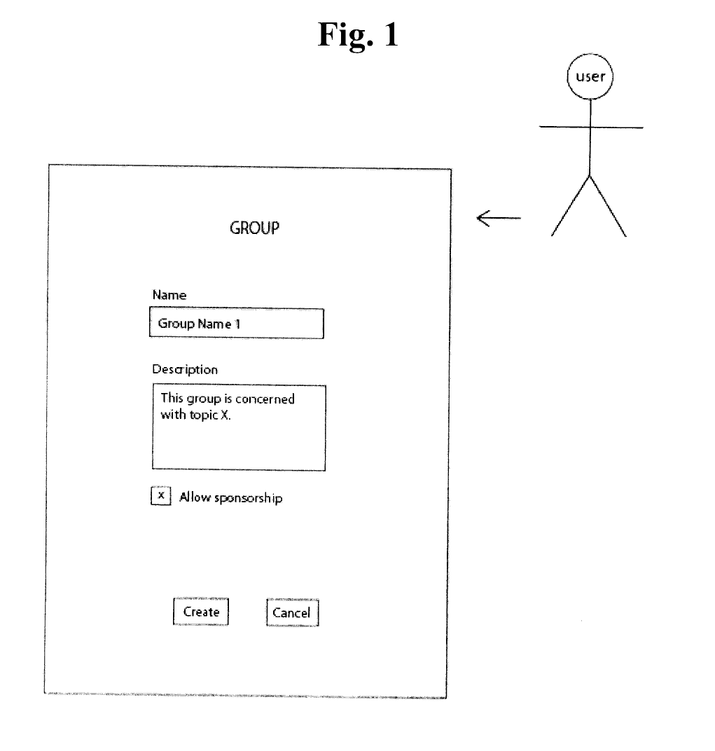

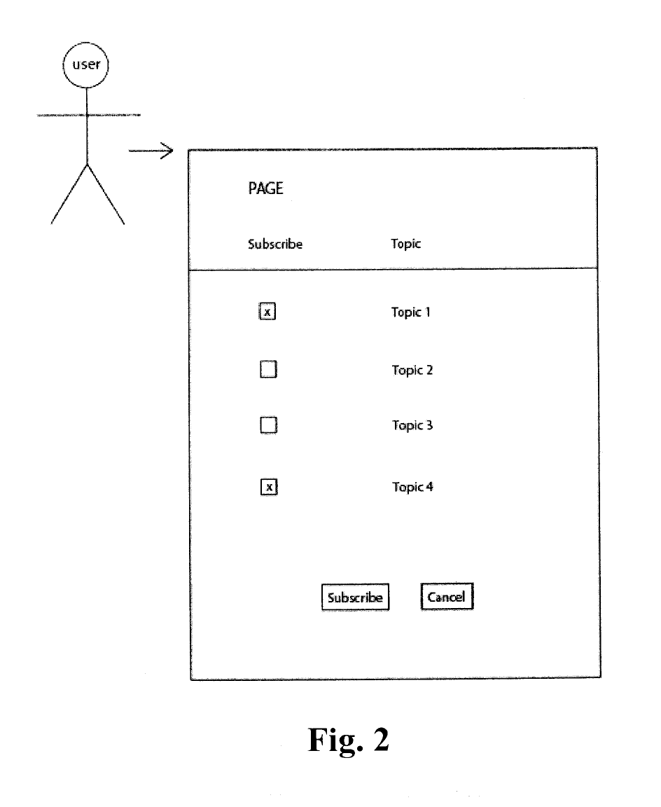

### DETAILED DESCRIPTION OF THE PREFERRED EMBODIMENTS

Well known methods, procedures, components, and circuitry have not been described in detail to avoid unnecessarily obscuring aspects of the present invention.

The detailed descriptions of the present invention in the following are presented graphically from the present embodiment and with accompanying process descriptions and representations as a means by which those experienced or skilled in the art can quickly ascertain the substance of its work.

The present invention is a business model, methods, and system for coupling the interests of real world social networks in doing voice message broadcast to their members and non-members alike—and coupling with that mass communications channel for reaching a sizeable aggregation of persons, the means for generating and/or distributing Telecom and Internet derived revenue.

The business model depends upon joining the interests of a social network interested in providing mass voice messaging services to its members and a voice message broadcast provider.

The business model depends upon joining the interests of a social network interested in providing mass voice messaging services to its members and a voice message broadcast provider. To set up voice message broadcast groups via an Internet web-interface

Voice message broadcast (VMB) example: Churches frequently need to get out important or critical messages to their staff or congregation. Using a phone tree or email can be both slow and tedious when time is critical and details are important. While the popularity of text messaging is increasing, the demographic majority of most church congregations does not utilize or have access to text messaging, so voice message broadcast in which a single recorded telephone message is transmitted to a group of message recipients is the only certain and reliable way of getting the information out to everyone on a timely basis.

Possible usage scenarios include;
Prayer requests
Devotionals
Schedule changes
Changes due to inclement weather
Volunteer requests
Bible study groups
Choir & band rehearsals
Visitor follow ups
Special events

The voice message broadcast (VMB) provider equips the administrators of a social network (church administrators) with the means to telephonically record, send and track permission based voice messages to their members—e.g., staff, congregation etc.
1. Speak—Voice message broadcast enables church administrators to conveniently connect with the congregation.
2. Send—Once a message is recorded, everyone in the group gets a call—from 1 to 1 million. (Real-time or future delivery.)
3. Manage and Track—Call tracking capability allows analysis of each call, such as, time of receipt, live answer or machine, duration of call, and whether the call was forwarded.
4. Message Header—Add a greeting message to play before each call
5. Message Footer—Add a message prompt after the greeting message
6. Telephonic Message Opt-out—Add an exit message to play after each call—enabling the call recipient to Opt-out of the receipt of further voice messaging.

The social network pays for the use of the voice message broadcast providers outbound telephonic voice messaging capabilities. This practice is already commonplace and is sub-served by call centers, telemarketing firms, and autodialing and robo-calling technologies.

However, the specific invention relates is not predicated upon this already commonplace activity, it is instead predicated upon the realization that there is considerable economic value intrinsic to a social network's existing person-aggregation, the relationship of the social network to its members, and the intrinsic value established by implementing a telephonic messaging channel into the social network's membership and interested others.

Tear Sheet; Page clipped from a newspaper or magazine and sent to the advertiser or advertising agency as proof that an ad was inserted as ordered. Generally, a tear sheet accompanies the invoice for the advertisement, as many advertisers will not pay their bill without evidence that the ad ran as ordered.

An authorized telephonic voice message into the membership of a real-world social network has the functional value of an advertising tear sheet. The present inventive business model and methods for its implementation are predicated on the here-to-date untapped value of person aggregation by real-world social networks and utilization of telephonic communication channels into those groups of people.

What is desired is a model that fuses the need of existing real-world social networks for a mass voice message broadcast utility with the need for a provider of such mass voice message broadcast to provide services to a large number of users without requiring the up front time and effort required to do the social networks person aggregation.

It is also desired to have a method for generating revenue from 3^{rd} parties to at least underwrite the cost of a social networks use of voice message broadcast.

Typically, in order to provide such resources to its members, a social network requires access to financial and employee resources, and to telephonic technology and equipment that most such networks do not possess. These requirements are difficult to satisfy for telecommunications companies, and even more so for organizations which are not used to operating in such an environment.

Our method consists in providing the social network with a self-administered telecommunications system that can be autonomously utilized and administered by members of the social network and by non-technical members of the social network's administrative staff. Administration and use of the telecommunications system is accomplished via an Internet web-interface.

A company capable of setting up and operating a voice message broadcast system managed via an Internet web-interface may not have the financial resources required to engage in the advertising, marketing, and sales activities needed to aggregate a large group of persons into a real world social network. This process of acquiring and retaining members is an important aspect of the success of any mass communications endeavor.

Such social networks may desire to utilize a voice message broadcast utility, but may prefer not, or be unable to make the up front investments needed to set up and operate their own voice message broadcast equipment.

Many real-world social networks desire to establish an Internet web-interface that can be a source of revenue, a platform for launching additional services, and a method of reinforcing their brand strength. Aggregating members and attracting non-members to a social network's web-interface is an important aspect of the success of any Internet based business and typically requires a set of skills different from those involved in developing Internet sites. In addition, building up a web-interface user base typically requires a substantial amount of time, a situation that may not be compatible with the relatively fast time cycles involved in the telecommunications and Internet economies.

The financial rewards that can be obtained by operating an Internet web-interface allowing discretionary access to and control of telephonic mass communications across a real-world social network will make such a combined telecomm and Internet web-interface a very attractive option for many social networks.

The Internet web-interface (system) provides the means to present and control voice message receipt and utilization and 3rd party voice message content that generates value for both the partner social network and the voice message broadcast provider. The web-interface features private administrative controls, individual user controls, and public message groups defined by the social network's administrators, authorized and sanctioned by the social network, and tailored to the members and interested non-members of the social network in their role as members and prospects of the network who use wired and wireless mobile voice communications devices. The Internet web-interface enables the social network and its individual members to control message presentation, construct/control message content, authorize or discontinue message receipt, control time and date of message receipt, and append ancillary electronic communications to voice messages.

Although a few embodiments of the present general concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A business model for generating and sharing advertising revenue with a social network by harnessing that network's person-aggregation and telephonic communications.
